(19) United States
(12) Patent Application Publication
(10) Pub. No.: US 2001/0035297 A1
(43) Pub. Date: Nov. 1, 2001

(54) Wiring material and connecting structure of said wiring material

(76) Inventor: Norihiko Tamai, Yokkaichi-City (JP)

Correspondence Address: CASELLA & HESPOS, 274 MADISON AVENUE, NEW YORK, NY, 10016

(21) Appl. No.: 09/824,169

(22) Filed: Apr. 2, 2001

(30) Foreign Application Priority Data
Apr. 19, 2000 (JP) 2000-118432

(51) Int. Cl. H01B 5/02

(52) U.S. Cl. 174/133 R

(57) ABSTRACT

An electric wire or flat cable is provided. The electric wire includes a core wire and the flat cable includes an array of parallel conductors. The core wire or the conductors are formed from a high electro-conductive resin. A terminal part is integrally molded at an end of the core wire of the electric wire or at the ends of the conductors of the flat cable. The core wire or the conductor are covered by an insulating resin.

### BACKGROUND OF THE INVENTION

1. Field of the Invention

The subject invention relates to a wiring material and to a connecting structure for such a wiring material.

2. Description of the Related Art

A conventional electric wire is shown in FIGS. 6 (A)and (B), and is identified by the numeral 1. The electric wire 1 comprises a core wire 1a, and an insulation coating 1b. The core wire 1a could be a single copper wire core or an array of twisted wires. The insulation coating typically comprises an insulation resin. The electric wire 1 is connected with a terminal metal fitting 2 by stripping the insulation coating 1b from the end of the electric wire 1 to expose the core wire la, and by connecting the core wire 1a and the terminal metal fitting 2 by pressure-clamping or pressure-welding. The wire 1 can be connected to a conductor on a printed circuit board through a connector mounted on the circuit board.

The prior art also includes a flat cable 5 as shown in FIG. 7. The flat cable 5 includes conductors 5a made of copper foil and cut in a narrow belt shape. Strips of the conductor 5a are arranged in parallel at fixed intervals, and both opposed faces of the conductors 5a are laminated with insulation resin films 5b, 5c. The flat cable 5 can be connected with the conductor of a printed board by using a connector fixed on the board.

The above-described electric wire can be connected with another electric wire or other instruments, such as an ECU. However, such a connection requires the use of a terminal metal fitting, and the steps of stripping the electric wire and pressure-clamping or pressure-welding the terminal metal fitting to the wire. Accordingly, there are problems due to the excess number of parts, substantial amounts of labor time and high costs.

A connector also is required to connect a flat cable with a printed circuit board. This also creates problems due to the excess number of parts, substantial amounts of labor time and high costs.

Further, there are problems relating to disposal of an electric wire or a flat harness. More particularly, an insulation coating material is a resin material and is different from the conductor. Therefore recycling is a problem and a separation step is required.

### SUMMARY OF THE INVENTION

The present invention was achieved considering the above-mentioned problems, and the object of the invention is to lower the production cost of an electric wire and a flat cable by forming a conductor and an insulation coating from the same material. Thus no separation work is required for disposal and the wire or flat cable has desirable recycle properties. Another object of the invention is to reduce of the number of parts required for connecting a wire or flat cable and to lower of the labor costs for completing connections with other electric parts.

The present invention relates to a wiring material for an electric wire or a flat cable suitably used for an automobile.

### BRIEF DESCRIPTION OF DRAWINGS

FIG. 1 is a perspective view, partially in section, showing the electric wire of a first embodiment.

FIG. 2 (A) and (B) are perspective views showing a step of forming a tab on the core wire of the above-mentioned electric wire.

FIG. 3 (A), (B) and (C) are schematic views showing use examples of the above-mentioned electric wire.

FIG. 4 is a perspective view showing the flat cable of a second embodiment of the invention.

FIG. 5 is a sectional view showing a condition in which the above-mentioned flat cable is connected with a printed board.

FIG. 6 (A) is a perspective view showing a conventional electric wire, and (B) is a side view showing a condition in which a terminal is connected with the conventional electric wire.

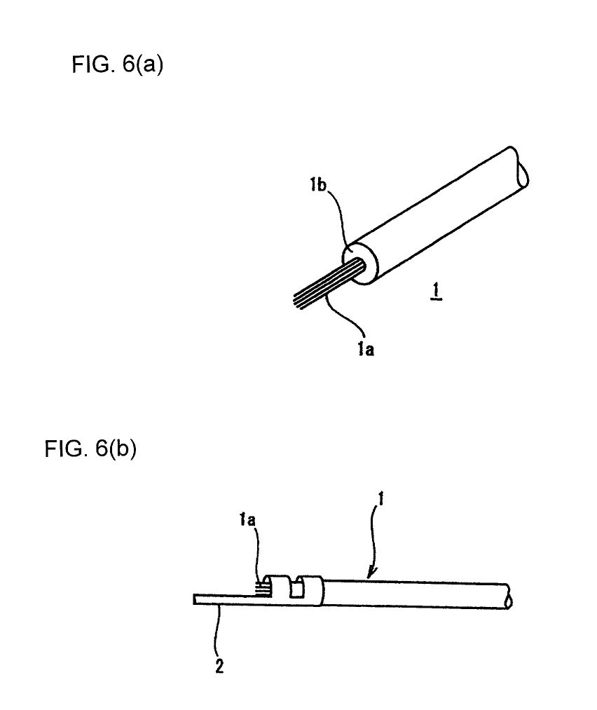

FIG. 7 is a drawing showing a conventional flat cable.

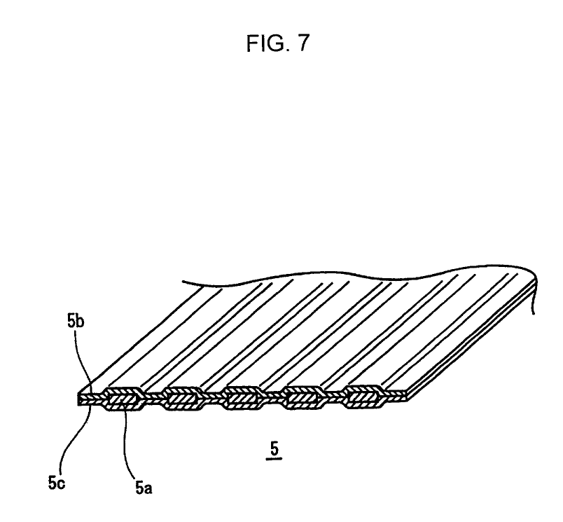

### DETAILED DESCRIPTION OF THE INVENTION

The present invention is directed to a wiring material comprising an electric wire with a round bar-shaped core. The round bar shape core comprises a highly electrically conductive resin. The electro-conductive resin of the core has an outer periphery that is coated by an insulation coating part composed of an insulation resin.

The end of the core protrudes from the insulation coating layer, and an terminal part is integrally molded at the end. The terminal part may be a tab shaped male terminal part that is formed by flattening the core, or may be a round terminal for earth connection by making a circular ring form.

Insulation coating may be stripped near the end of the wire to expose the core wire, then the core wire is formed into a tab shape by press molding or heat molding. Alternatively, a tab may be preliminarily molded at the end of the core before applying the insulation coating. The molded part at the end of the core wire may be a round terminal part or a female terminal part.

Thus, the terminal part at the end of the core of an electric wire is integrally molded such that the core can be connected directly with another electric wire or other electric parts. Therefore it becomes unnecessary to connect a separate terminal metal fitting, the number of parts can be reduced, and the connection work of the terminal metal fitting can be abbreviated.

The present invention also provides a wiring material comprising a flat cable. The flat cable comprises belt conductors composed of a highly electrically conductive resin arranged in parallel at fixed intervals. The parallel conductors are laminated by coverings of an insulation film on both faces.

The highly electrically conductive resin used for the above-mentioned electric wire or flat harness is composed of a product obtained by mixing a metal fiber in a thermoplastic resin. The metal fiber may comprise copper, nickel, iron and the like. The electro-conductive resin also may comprise a low melting point alloy of a lead-free solder (low melting point solder) or a copper powder dispersed in a thermoplastic resin as disclosed, for example in Japanese Patent Publication (Unexamined) Hei No.10-237331 and No.11-342522.

The thermoplastic resin in which an electrically conductive metal fiber is compounded may be polypropylene, polyethylene, polystyrene, acrylonitrile-butadiene-styrene resin, modified polyphenylene oxide resin, polybutyleneterephthalate resin, polyamide resin, aromatic polyamide resin, polyphenylene sulfide resin, liquid crystal polymer, polyether imide, polybenzimidazol, polyether ether ketone, polyether sulfone or the like. These resins can be used alone or by blending. Acrylonitrile-butadiene-styrene and polybutyleneterephthalate are the preferred resins.

The low melting point alloy is dispersed by mixing in the above-mentioned thermoplastic resin and joined in a network shape. The low melting point alloy preferably has a melting point of 100° C. or more and preferably 200° C. or more, and preferably is an alloy melted at injection molding. The alloy may be an Sn-Pb type, an Sn-Ag-Pb type, an Sn-Bi type, an Sn-Bi-In type, a Bi-Pb type, a Bi-Sn type, an Sn-Cu type, an Sn-Cu-Ni-P type, an Sn-Ag type, an Sn-Bi-Pb type or an Sn-In type.

The electric wire in which the above-mentioned high electro-conductive resin is a conductor preferably is produced by two steps. The first step comprises molding a core with the highly electrically conductive resin by injection molding (the first shot), and coating an insulation resin on the outer periphery of the core while pulling the core to form an insulation coating. The flat cable also is produced by molding a highly electrically conductive resin to form narrow belt-like conductors, and laminating insulation film on both faces of the conductors while pulling the conductors in parallel.

When the above-mentioned electric wire or flat cable is connected with the conductor of a printed circuit board, the core of the electric wire or the conductor of the flat cable is mounted in a penetration hole which is formed by drilling in sequence on the conductor and board of the printed circuit board. The highly electrically conductive resin then is melted by heating and filled in the penetration hole. Accordingly, the separate connector that had been required for connecting the conductor of the printed circuit board with the electric wire or flat cable is unnecessary. Therefore, connecting parts can be deleted, the required labor for connection can be also reduced, and the cost of a product can be reduced remarkably.

Further, when the core wire of the electric wire or the conductor of the flat cable is molded with the highly electrically conductive resin, it becomes the same kind of material as the insulation coating comprising the insulating resin. Therefore, the separation step at disposal becomes unnecessary, and recycle properties can be enhanced.

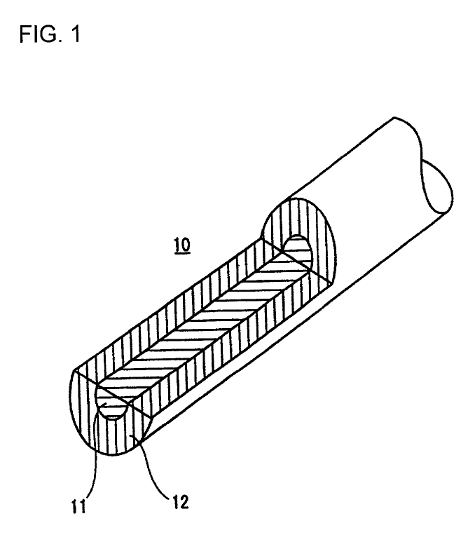

FIG. 1 to FIG. 3 show a wiring material comprising an electric wire 10 in accordance with the invention. The electric wire 10 comprises a core 11 formed from a highly electrically conductive resin that is coated by an insulation coating 12 composed of an insulating resin.

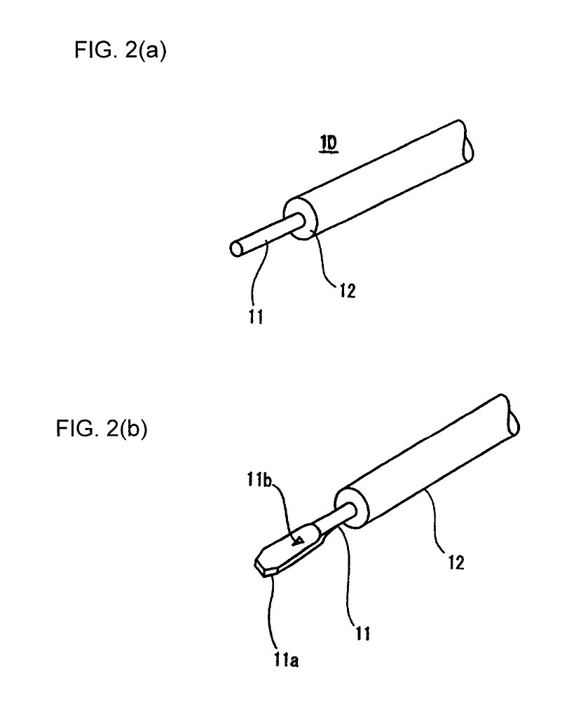

FIG. 2(A) and (B) show a product obtained by molding a tab 11a as a male terminal part unitarily with the core 11 at the end of the electric wire 10. As shown in FIG. 2(A), the insulation coating 12 at the end of the electric wire 10 is stripped to expose the core 11. The core 11 is deformed in a flat shape by pressing the exposed portion of the core wire 11 while heating. The tab 11a is the male terminal part and is formed at portions of the core 11 that protrude from the insulation coating part 12, as shown in FIG. 2(B). Further, according to product specification or requirement, a hooking hole 11b is provided by drilling or punching the tab 11a .

The electric wire 10 may have a specified fixed length. In this situation, the tabs 11a and the hooking holes 11b are molded preliminarily at both ends as part of the core molding step, and the insulation coating part 12 may be coated on said core 11 excluding the tabs 11a at both ends.

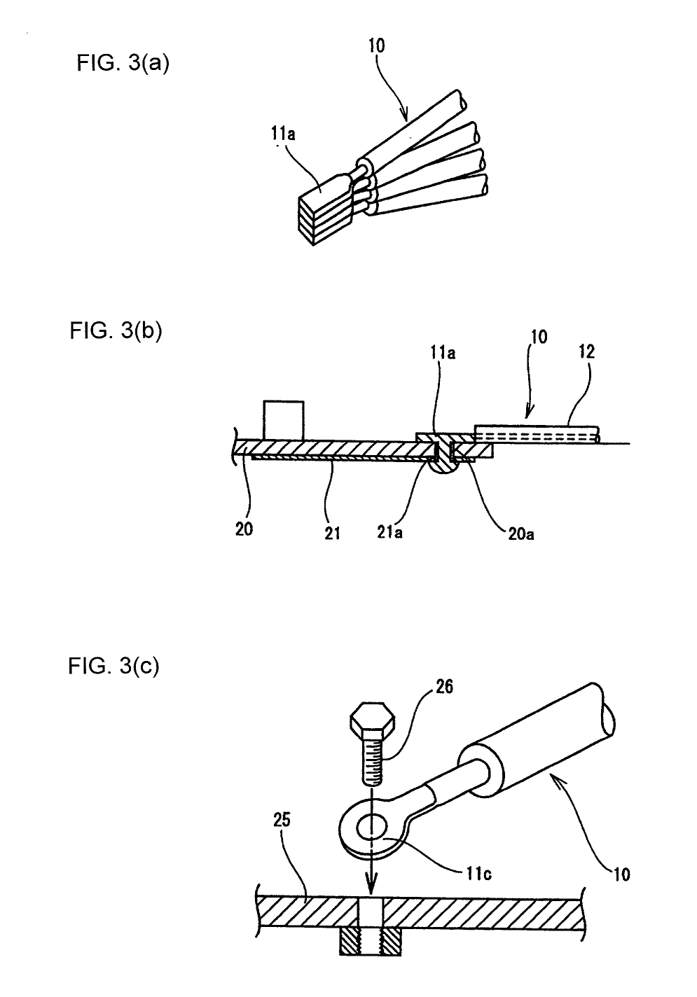

The electric wire 10 may be connected with another conventional electric wire by being connected with the end of the other electric wire and inserted in the female terminal part to be hooked. Further, as shown in FIG. 3(A), a terminal-concentrated splice can be formed by piling the tabs 11a of terminals of a plurality of the electric wires 10, heating and mutually welding. As shown in FIG. 3(B), the electric wire 10 can be connected with a printed board 20 by piling the tab 11a of the electric wire 10 on the board 20 at a location registered with the penetration holes 20a, 21a, melting the tab 11a by heating, and then filling in the penetration holes 20a, 21a with the melted conductive resin of the tab 11a to make a rivet shape.

FIG. 3(C) shows a round terminal 11c that is molded preliminarily at the end of the core 11. The round terminal 11c is used as an earth terminal, and is fixed on a car body 25 by being a bolt 26.

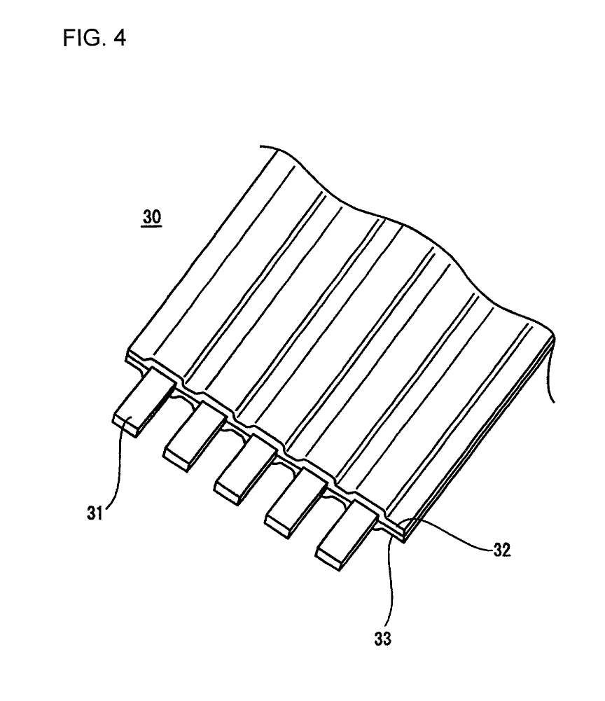

FIG. 4 shows a wiring material that comprises a flat cable 30 in accordance with the second embodiment of the invention. The flat cable 30 includes belt conductors 31 composed of a highly electrically conductive resin that are arranged in parallel at fixed intervals, and laminated by covering the insulation films on both faces. The end of the flat cable 30 also exposes the conductors 31 by stripping the insulation films 32, 33. Further, in a manner similar to the electric wire, the conductor 31 may be preliminarily molded in a condition in which the conductors 31 are exposed at the end of the flat cable 30.

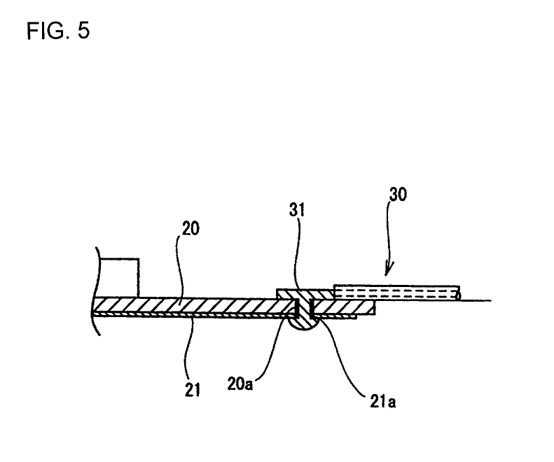

The above-mentioned flat cable 30 is connected with the printed board 20, as shown in FIG. 5, by the conductors 31 on the board 20 such that the respective conductors are registered with the penetration holes 20a, 21a, melting the conductors 31 by heating, and the filling in the penetration holes 20a, 21a with the melded conductive resin of the conductors 31 to make a rivet shape.

Further, the core 11 of the electric wire 10 of the first embodiment and the conductors 31 of the flat cable 30 of the second embodiment may be connected with the conductor 21 of the printed board 20 according to the above-mentioned procedure.

As shown by the illustrations, the present invention provides a highly electrically conductive resin in place of a conventional copper as the core of an electric wire and the conductor of a flat cable. This core can be welded directly on the conductor of a flat cable and the like by heating the core wire the conductor. Accordingly, the conventional connector becomes unnecessary.

Further, an end of the core may be formed into the terminal prior to application of the insulation coating. Thus the number of parts and the number of connection steps can be reduced.

Both the electric wire and the flat cable use a highly electrically conductive resin in place of a metal such as copper or the like, and a wiring material conventionally constituted by different materials (a metal and a resin) is changed to the wiring material constituted by the same kind of materials (a highly electrically conductive resin and an insulating resin). Accordingly, the separation step of materials at disposal is unnecessary, and recycle property can be enhanced.

What is claimed is:

1. An electric wire comprising a round-bar shape core formed from a highly electrically-conductive resin and an outer insulating resin cover covering the core.

2. The electric wire of claim 1, wherein the core wire has an end protruded from the insulating resin cover, and a terminal part being integrally molded on the protruded end.

3. A flat cable comprising a plurality of belt conductors formed from a highly electrically conductive resin, said belt conductors being arranged in parallel at a fixed interval, and said belt conductors being laminated by covering an insulation film on both faces.

4. A connection structure for an electric wire, said wire comprising a core formed from a highly electrically conductive resin and having an end formed to define a terminal, an insulating resin cover covering portions of the core wire at locations spaced from the terminal, the terminal being welded to a penetration hole provided on a printed circuit board and connected integrally with a conductor of the printed circuit board.

5. A wire comprising at least one conductor formed from a selected resin having a conductor therein, said conductor having an end formed to define a terminal part, portions of the conductor spaced from the terminal part being covered with an insulating coating, said insulating coating being formed from the selected resin.

6. The wire of claim 5, wherein the at least one conductor comprises a single bar-shaped conductor.

7. The wire of claim 5, wherein the at least one conductor comprises a plurality of parallel belt-shaped conductors disposed at substantially equal intervals.

8. The wire of claim 5, wherein the resin is a thermoplastic resin selected from the group consisting of polypropylene, polyethylene, polystyrene, acrylonitrile-butadiene-styrene resin, modified polyphenylene oxide resin, polybutyleneterephthalate resin, polyamide resin, aromatic polyamide resin, polyphenylene sulfide resin, liquid crystal polymer, polyether imide, polybenzimidazol, polyether ether ketone, and polyether sulfone.

9. The wire of claim 5, wherein the resin is acrylonitrile-butadiene-styrene.

10. The wire of claim 5, wherein the resin is polybutyleneterephthalate.

11. The wire of claim 5, wherein the resin having a conductor therein comprises a thermoplastic resin with a low melting point alloy disbursed therein.

12. The wire of claim 11, wherein the low melting point alloy has a melting point of at least 100° C.

13. The wire of claim 11, wherein the low melting point alloy is selected from the group consisting of Sn—Pb, Sn—Ag—Pb, Sn—Bi, Sn—Bi—In, Bi—Pb, Bi—Sn, Sn—Cu, Sn—Cu—Ni—P, Sn—Ag, Sn—Bi—Pb and Sn—In.

14. A method for forming a wire, comprising: providing a selected resin mixed with a conductive material to form a conductive resin; forming the conductive resin into an elongated configuration; forming an end of the elongated conductive resin into a terminal part; and coating portions of the elongated conductive resin with an insulating material from the selected resin.
